(19) United States
(12) Patent Application Publication
(10) Pub. No.: US 2009/0262130 A1
(43) Pub. Date: Oct. 22, 2009

(54) SYSTEM AND METHOD FOR AUTOMATICALLY GENERATING COLOR SCHEME VARIATIONS

(75) Inventor: Roberto X. Ramirez, Malden, MA (US)

Correspondence Address: VISTA PRINT USA, INC.;ATTN: PATENT COUNSEL, 95 HAYDEN AVENUE, LEXINGTON, MA, 02421, US

(73) Assignee: VistaPrint Technologies Limited

(21) Appl. No.: 12/106,832

(22) Filed: Apr. 21, 2008

(51) Int. Cl. G09G 5/02

(52) U.S. Cl. 345/595

(57) ABSTRACT

Methods and systems for generating color scheme variations of a graphical design based on a current color scheme of the design include rotating the colors of the current color scheme by predetermined angular rotations on a color wheel.

### FIELD OF THE INVENTION

This invention relates to graphical design, and more particularly to automatically generating a set of color scheme variations based on a current color scheme of an electronic document.

### BACKGROUND OF THE INVENTION

A graphical design includes a combination of graphical content text, and color. The choice of colors used in a design is often referred to as the “color scheme” of the design. For example, the use of a white background with black text is an example of a basic and common default color scheme in an electronic word processing document. A common color scheme of a web browser application includes different hues of blue, grey and white to render the browser window including title bar, toolbars, and scrollbars.

Different color schemes may be used to define particular styles, evoke impressions and feelings from a viewer, and to create a general appeal. Colors that create an aesthetic feeling when used together will often accompany each other in color schemes. A basic color scheme may include two colors that create a certain appeal together. More advanced color schemes involve several colors in combination, including colors of different hue, and even colors comprising different shades of a single color.

Color schemes are often described in terms of logical combinations of colors on a color wheel. A color wheel is an organization of color hues around a circle, showing relationships between colors considered to be primary colors, secondary colors, complementary colors, etc.

Artists typically use red, yellow, and blue primaries (RYB color model), so these are arranged at three equally-spaced points around their color wheel. Printers and others who use modern subtractive color methods and terminology use magenta, yellow, and cyan as subtractive primaries.

Electronic displays such as TV screens and computer monitors utilize light-emitting sources to display color. The primary colors for these devices are red, green, and blue (RGB), whereby various combinations of red, green and blue light add to produce hue, saturation, and brightness.

Intermediate and interior points of color wheels and circles represent color mixtures. In an RGB or other light-emitting source color wheel, the center is usually white, representing the combination of all colors of light.

Graphical design applications allow a user to create and edit a graphical design. Such applications typically include a color palette that allows the user to select the colors of the elements in the design. Such applications may also allow a user to change a color scheme to one of a number of pre-selected sets of colors, called color schemes. However, these color schemes are pre-determined by the application designer and limit the user to selection of one of the pre-determined color schemes or to full autonomy in creating the desired color scheme. If the user creates a customized color scheme, there is currently not available any easy and efficient technique for automatically creating variations of the customized color scheme.

Thus, it would be desirable to have available a graphical control which automatically generates color scheme variations based on a given color scheme, in particular a color scheme determined by the colors in a given design. It would further be desirable to present to a user the color scheme variations and allow the user to select a particular color scheme variation and to automatically update a design displayed in a work area to the colors of the selected variation.

### SUMMARY OF THE INVENTION

Embodiments of the invention are directed to automatically generating color scheme variations based on a current color scheme of an electronic design.

In accordance with one embodiment of the invention, a computer-implemented method for automatically generating a set of color scheme variations based on a current color scheme of an electronic document, includes steps of determining an original color scheme of an electronic design, the original color scheme comprising an original set of colors used to implement an electronic design, mapping the colors in the original set of colors to respective points at respective locations on a color wheel, rotating each of the points around the color wheel by a same rotation to respective new locations, determining corresponding new colors associated with the rotated points at the respective new locations on the color wheel; and presenting at least a subset of the new colors associated with the rotated points as a color scheme variation of the original color scheme.

In accordance with another embodiment of the invention, a computer-readable medium comprising program instructions which, when executed by a computer, implement the above method for automatically generating a set of color scheme variations based on a current color scheme of an electronic document.

In accordance with yet another embodiment of the invention, a system for automatically generating a set of color scheme variations based on a current color scheme of an electronic document, includes a processor, a display, an input device which detects and receives user input, a graphical design application executed by the processor which presents a graphical user interface on the display and receives user input from the input device to create a design in a work area of the graphical user interface, and a color scheme variation control which determines an original color scheme of an electronic design, the original color scheme comprising an original set of colors used to implement an electronic design, maps the colors in the original set of colors to respective points at respective locations on a color wheel, rotates each of the points around the color wheel by a same rotation to respective new locations, determines corresponding new colors associated with the rotated points at the respective new locations on the color wheel, and presents at least a subset of the new colors associated with the rotated points as a color scheme variation of the original color scheme.

It is an advantage of the invention that variations of an original color scheme which may offer similar aesthetic appeal are automatically generated for presentation to a user of a graphical design application to allow the user to quickly select an alternate yet similarly appealing color scheme.

These and other objects, features and advantages of the invention will be better understood with reference to the accompanying drawings, description and claims.

### BRIEF DESCRIPTION OF THE DRAWINGS

FIG. 1 is an exemplary graphical user interface window of an example graphical design application.

FIG. 2 is block diagram of an exemplary color scheme variation control.

FIG. 3 is an exemplary example of a color wheel.

FIGS. 4A through 4D are depictions of the color wheel of FIG. 3, illustrating the rotation of mapped colors by differing angular rotation.

FIG. 5 is the graphical user interface window of FIG. 1 after a user has activated the color scheme variation control.

FIG. 6 is a flowchart of an example method for automatically generating color scheme variations.

FIG. 7 is a block diagram illustrating the transformations involved in implementing the color wheel rotation.

FIG. 8 is an exemplary computing environment in which the invention may operate.

### DETAILED DESCRIPTION

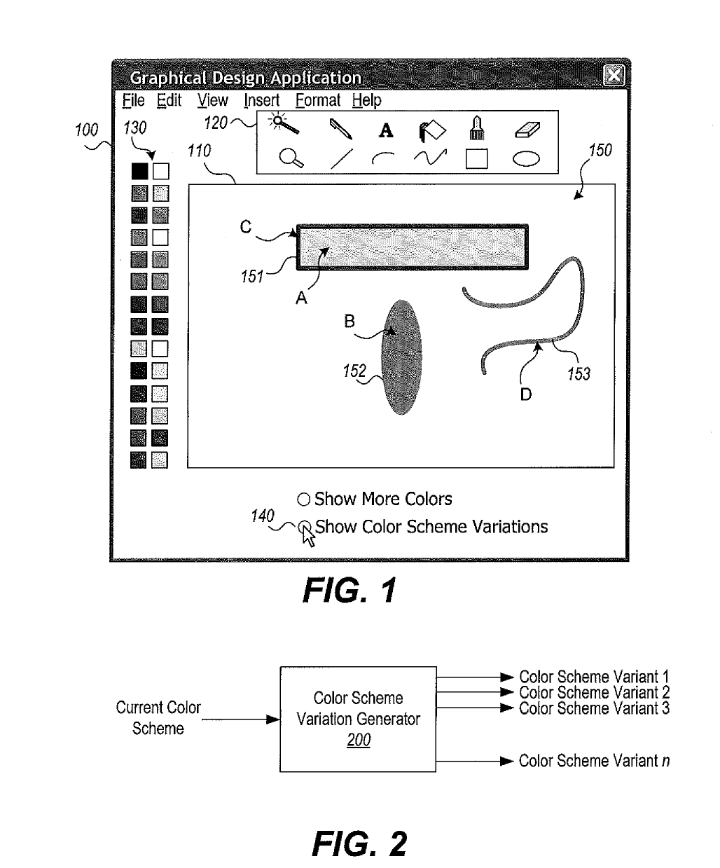

FIG. 1 depicts a window 100 illustrating a user interface of an example graphical design application. As shown therein, the window 100 includes a work area 110, a plurality of formatting and editing controls 120, a color palette 130, and a color scheme variation control 140.

A user may utilize a mouse or other input device to activate the formatting and editing controls 120 to create a design 150 within the work area 110. The formatting and editing controls 120 may include a select control which allows a user to select an element in the work area, a magnify control which allows a user to set the zoom (magnification) level of the content displayed in the work area 110. The editing controls may include a pen tool which allows a user to draw an object in the work area 110, a text tool which allows a user to enter text in the work area 110, a fill tool which allows a user to fill elements in the work area 110 with color and effects, a paint tool which allows a user to paint areas in the work area 110 with color and effects, an erase tool which allows a user to erase content from the work area 110, a line tool which allows a user to draw straight lines in the work area 110, an arc tool which allows a user to draw controlled arcs in the work area 110, a freeform tool which allows a user to draw freeform lines in the work area 110, a box tool which allows a user to create rectangular boxes in the work area 110, and an ellipse tool which allows a user to create elliptical shapes in the work area 110.

In the example shown in FIG. 1, an example design 150 has been created in the work area 110. The example design 150 includes a rectangle 151 filled in a first color A and outlined in a color C, an ellipse 152 filled in a color B, and a line 153 of color D. The colors of the design elements may be set by selecting an element and then clicking on a desired color for the element in the color palette 130. Color selection in this manner is well-known in the electronic graphic design art. The colors selected for the elements in the design together comprise the current color scheme of the design 150.

FIG. 2 is a block diagram illustrating a color scheme variation control 200 which receives a color scheme and generates a plurality of different color schemes, Color Scheme Variants 1 through n, based on the current color scheme.

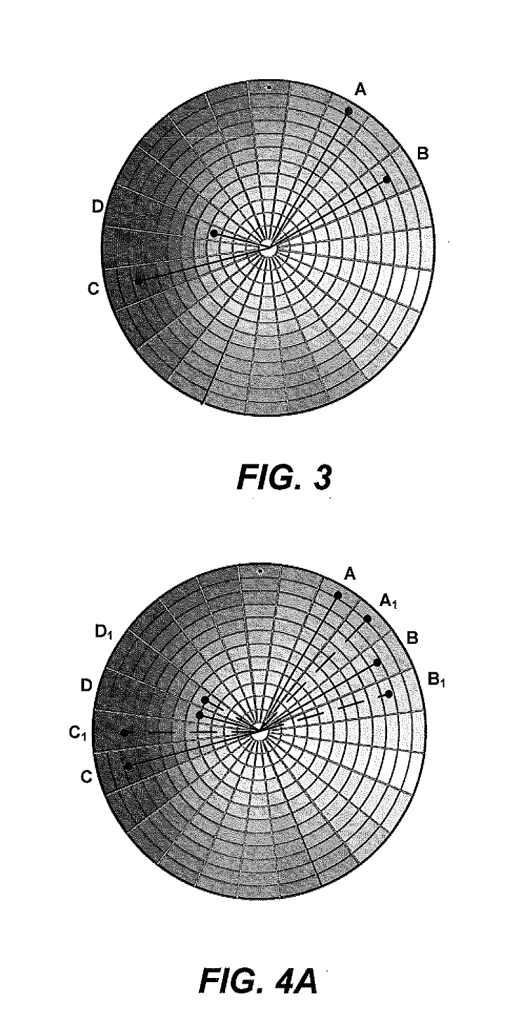

An example color wheel 300 is illustrated in FIG. 3. Different hues (pure color) are represented by different angles around the circle. In a digital image, the way a color is represented depends on the color model used by the particular system. For example, the RGB (red, green, blue) color model is a simple additive model, wherein the intensity of each component (red, green and blue) of a color is represented on a scale of 0 to 255, where 255 represents full intensity. The individual color values are then added to give the overall color. Black is represented by the RGB(0,0,0); white is represented by (255, 255, 255); red is represented by RGB(255,0,0); Blue is represented by RGB(0,0,255); Green is represented by RGB(0,255,0); Cyan is represented by RGB(0,255,255), Magenta is represented by RGB(255,0,255), Yellow is represented by RGB(255,255,0), and other colors are represented by various other combinations of the RGB component colors. In electronic displays, colors are generated by combining red, green, and blue light, and thus the RGB model is utilized for rendering purposes.

An alternative color model is the HSL (hue, saturation, luminosity) model which represents the color of a pixel in terms of hue (pure color), saturation (intensity of the color), and luminosity (brightness). Other color models exist and there are known techniques in the art for characterizing a color, and for characterizing differences in colors of different pixels.

The color wheel 300 in FIG. 3 represents different hues according to the rotational angle around the wheel's circle. Saturation may be represented by the radial distance from the center of the circle, where highest saturation is represented at the outer periphery of the circle and lowest saturation is represented at the center of the circle. In the color wheel model, luminosity or brightness is a constant.

Referring now to the example design 150 in the work area 110 of the graphical design application's graphical user interface of FIG. 1, the colors, A, B, C, and D used for the elements 151, 152, 153 map to corresponding points A, B, C, and D on the color wheel 300, as illustrated in FIG. 3. The colors used in the design 150 in the work area 110 (in the present example, the four colors A, B, C, and D, but may in practice comprise any number of different colors) together define a “current color scheme” of the design 150.

To generate a variation of a current color scheme of a design, the color scheme variation control 140 rotates each color A, B, C, D in the current color scheme by a predetermined amount around the color wheel 300. In an exemplary embodiment, the graphical design application supports up to 720 different hues, spaced equally around the 360° color wheel. Thus, a different variation of the current color scheme may be generated, based on pure hue rotation alone, by rotating each color in the current color scheme by a multiple of 15° to generate up to 24 different color schemes.

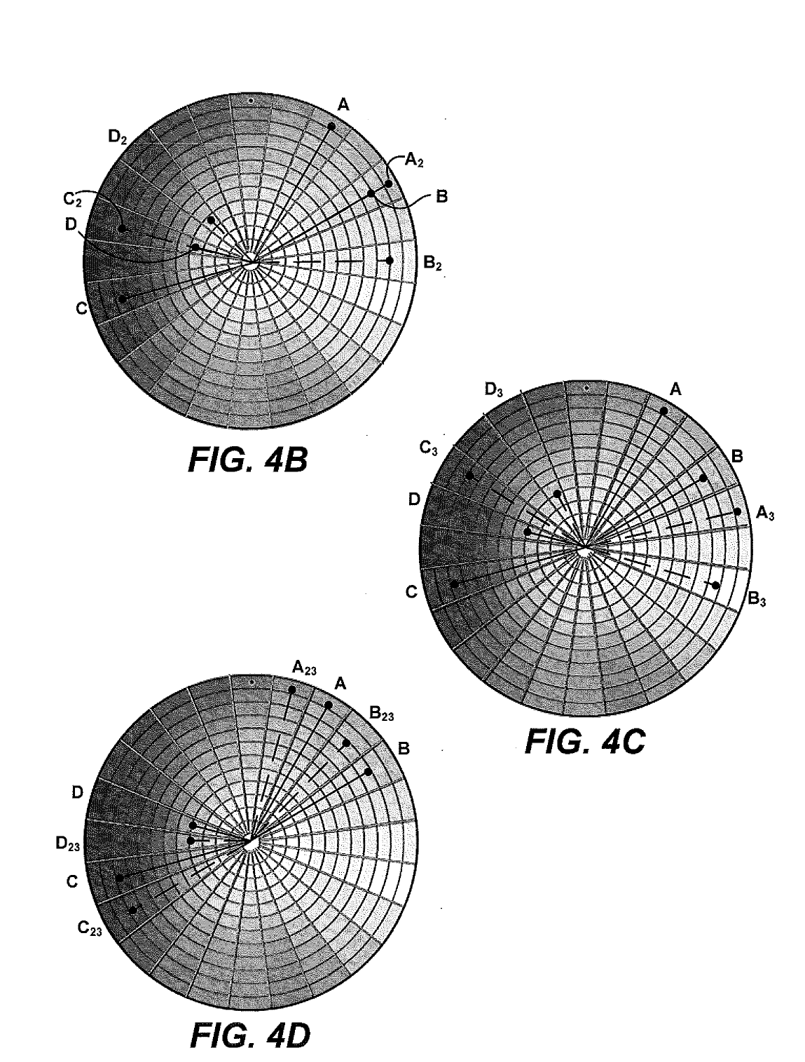

FIGS. 4A through 4D illustrate the rotation of the colors A, B, C, D of the current color scheme by multiples of 15° to generate color scheme variations V₁, V₂, V₃, . . . , V₂₃. Each color scheme variation V₁, V₂, V₃, . . . , V₂₃ is a version of the current color scheme V={A, B, C, D} where each color A, B, C, D is rotated a multiple of 15° around the color wheel, and wherein the angle of rotation represents the hue of a color. Preferably, other components of the color, for example saturation and brightness (or luminosity) are held constant. All colors A′, B′, C′, D′ in any given color scheme variation V′ are rotated by the same multiple of the predetermined angle of rotation. Thus, a first color scheme variation V₁, illustrated in FIG. 4A, comprises the set of colors {A₁, B₁, C₁, D₁}, where A₁=A+(1*15°), B₁=B+(1*15°), C₁=C+(1*15°), and D₁=D+(1*15°). A second color scheme variation V₂, illustrated in FIG. 4B, comprises the set of colors {A₂, B₂, C₂, D₂}, where A₂=A+(2*15°), B₂=B+(2*15°), C₁=C+(2*15°), and D₁=D+(2*15°). Thus, all colors A₂, B₂, C₂, D₂ in the second color scheme variation V₂ are rotated from the original colors A, B, C, D, by 30°. A third color scheme variation V₃, illustrated in FIG. 4C, comprises the set of colors {A₃, B₃, C₃, D₃}, where A₃=A+(3*15°), B₃=B+(3*15°), C₃=C+(3*15°), and D₃=D+(3*15°). Thus, all colors A₃, B₃, C₃, D₃ in the third color scheme variation V₃ are rotated, on the color wheel, from the original colors A, B, C, D, by 45°. Consecutive rotations of the colors by 15° may be continued to generate additional color scheme variations up to 24 total color scheme variations (including the original color scheme). FIG. 4D illustrates the twenty-third color scheme variation V₂₃, which comprises the set of colors {A₂₃, B₂₃, C₂₃, D₂₃}, where A₂₃=A+(23*15°), B₃=B+(23*15°), C₃=C+(23*15°), and D₃=D+(23*15°). Thus, all colors A₂₃, B₂₃, C₂₃, D₂₃ in the third color scheme variation V₂₃ are rotated, on the color wheel, from the original colors A, B, C, D, by 345°.

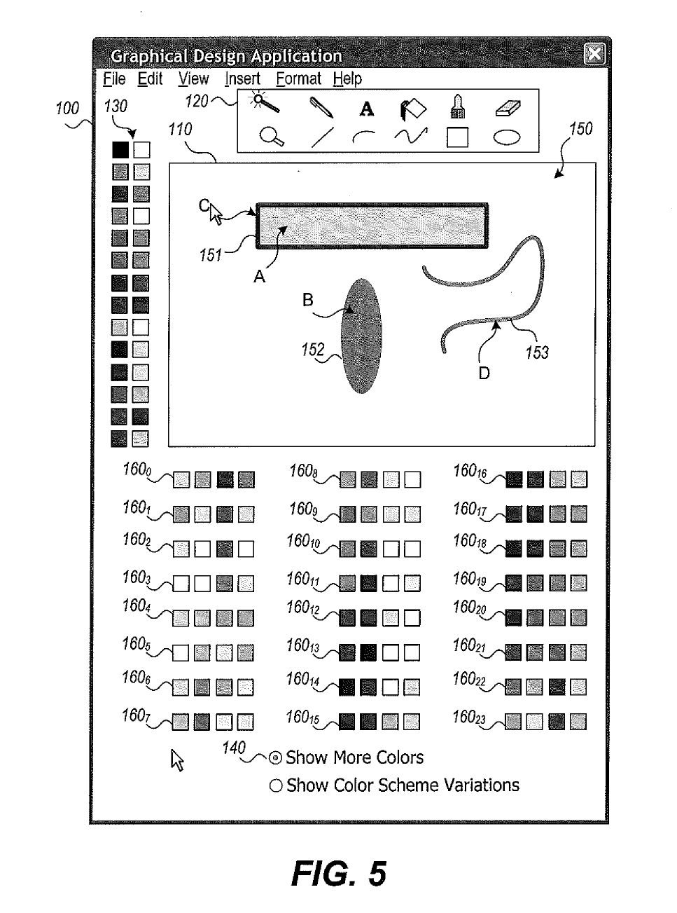

FIG. 5 depicts the window 100 of FIG. 1 after the user has clicked on the Show Color Scheme Variations radio button 140. Clicking on the Show Color Scheme Variations radio button 140 activates the color scheme variation control 200 of FIG. 2 to rotate the colors A, B, C, D in the work area 110 which make up the current color scheme by 24 consecutive multiples of 15° to generate 24 different color scheme variations V₁, V₂, V₃, . . . , V₂₃. The color scheme variations V₁, V₂, V₃, . . . , V₂₃ may be stored in memory.

Each color scheme V, V₁, V₂, V₃, . . . , V₂₃ may be represented by a color swatch 160₀, 160₁, 160₂, . . . , 160₂₃ comprising at least a subset of colors in the respective color scheme. The subset of colors selected for the displayed swatch may be selected according to any desired selection criteria.

In one embodiment, the swatch color selection criteria is selection of the dominant colors used in the design of the work area. The dominant colors may be a subset of the colors in the color scheme that are used to render the largest number of pixels in the work area 110. Alternatively, the dominant colors may be a subset of the colors in the color scheme that are used for specific elements of the design. For example, although the background of the work area 110 comprises the largest number of pixels in the design 150, if the background color is to be held constant, or is not to be considered as part of the design itself, for example in the case of the design of a logo that may be displayed or printed on any number of different backgrounds, those pixels rendering the background may be disregarded in the total pixel count when determining the respective number of pixels associated with the different colors for determination of the dominant colors in the design.

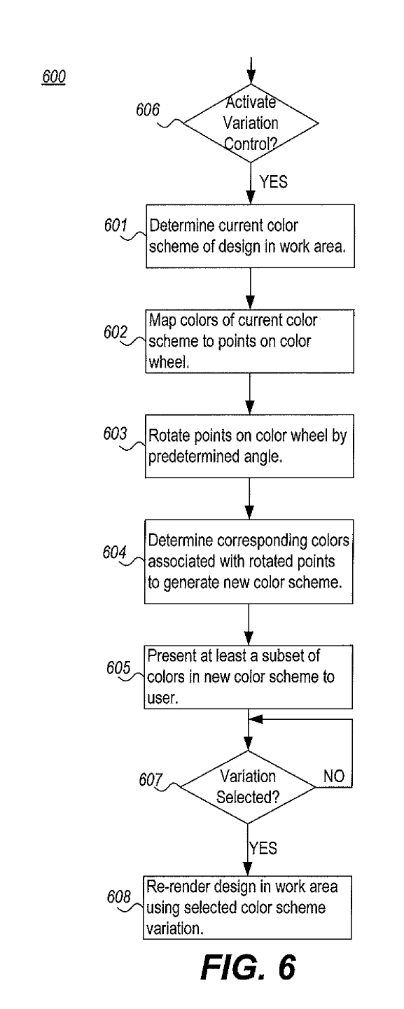

Each swatch 160₀, 160₁, 160₂, . . . , 160₂₃ displayed in the user interface of the graphical design application in FIG. 5 represents a different variation of the current color scheme of the design 150 in the work area 110. When a user selects one of the swatches 160₀, 160₁, 160₂, . . . , 160₂₃, for example by clicking on swatch 160₃, with the mouse pointer 101 as illustrated in FIG. 5, the design 150 displayed in the work area 110 will be re-rendered using the colors of the selected swatch. Thus, if swatch 160₃ is selected, original color A will be rendered as color A₃, original color B will be rendered as color B₃, original color C will be rendered as color C₃, and original color D will be rendered as color D₃. FIG. 6 illustrates the window 100 after the user has selected swatch 160₃. The swatches 160₀, 160₁, 160₂, . . . , 160₂₃ continue to be displayed until the user deactivates the Show Color Scheme Variation radio button 140.

If the swatches 160₀, 160₁, 160₂, . . . , 160₂₃ are displayed (because the Show Color Scheme Variation radio button 140 is activated) and the user changes the color of an element 151, 152, 153 of the design 150, or adds a new element with anew color to the design 150, the color scheme variation control 200 will automatically update the color scheme variations and re-render the swatches 160₀, 160₁, 160₂, . . . , 160₂₃ according to the updated color scheme variations.

In implementation, the color scheme variation control includes a graphical user interface component which detects a click event on the Show Color Scheme Variation radio button, an application component which actually performs the computations for generating the color scheme variations, and another graphical user interface component which renders the swatches of the color scheme variations on the user's display.

Detection of click events resulting from a click on a radio button by a user interacting with a graphical user interface is well-known in the art, as is the rendering I s of color swatches in graphical user interfaces FIG. 6 is a flowchart depicting the steps performed by the application component of the color scheme variation control which actually generates the color scheme variations.

As illustrated in FIG. 6, the method 600 for automatically generating a set of color scheme variations based on a current color scheme of an electronic document includes the steps of determining an original color scheme of an electronic design including an original set of colors used to implement an electronic design (step 601), mapping the colors in the original set of colors to respective points at respective locations on a color wheel (step 602), rotating each of the points around the color wheel by a same degree of rotation to respective new locations on the color wheel (step 603), determining corresponding new colors associated with the rotated points at the respective new locations on the color wheel (step 604), and presenting on a user display at least a subset of the new colors associated with the rotated points as a color scheme variation of the original color scheme (step 605). Steps 603 through 605 may be repeated a plurality of times to generate and present to a user a plurality of different color scheme variations.

The method 600 may be incorporated into a graphical user interface which includes a click event control which detects a click event for activating the color scheme variation generation. In this embodiment, the method may further include detecting activation of the color scheme variation control (step 606) and executing the steps 601 through 605 upon detection of activation of the color scheme variation control.

The method 600 may further include detecting user selection of one of the presented color scheme variations (step 607) and re-rendering the electronic design in the work area using the selected color scheme variation (step 608).

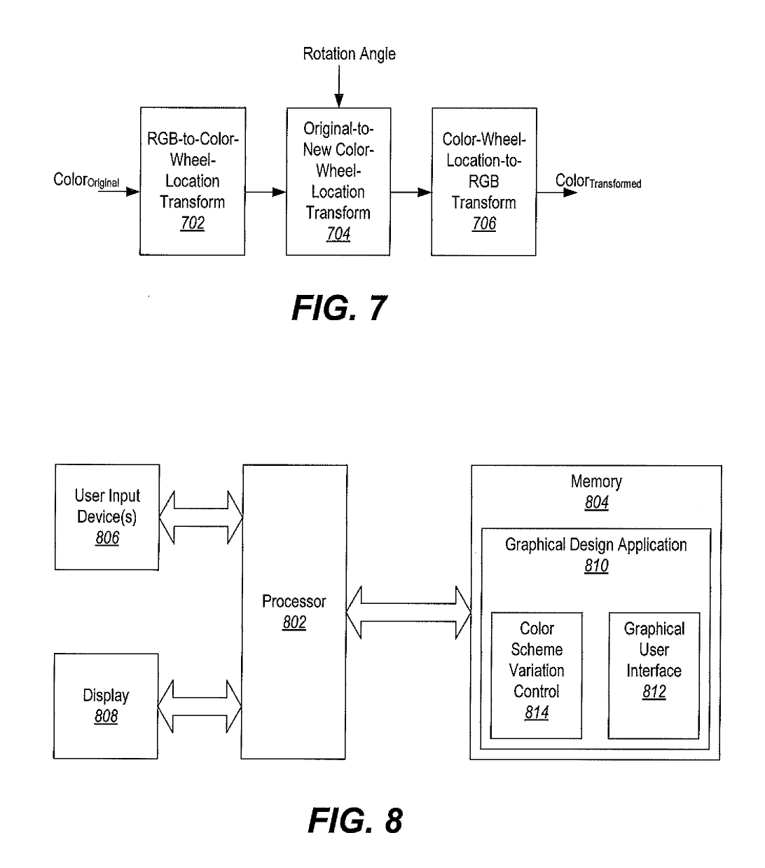

It will be appreciated by those skilled in the art that although conceptually the color scheme variations are generated by rotating an original color scheme around a color wheel, the actual mapping and rotation itself may be performed by way of mathematical transformations rather than by actually implementing a color wheel for display to a user. That is, as illustrated in FIG. 7, a mathematical model representing the color wheel may be generated such that given an RGB color Color_{Original}, the resulting position of the given color may be retrieved by way of an RGB-to-Color-Wheel-Location Transform 702. Further, given a retrieved position of an original color 703 and a desired rotation angle 705, an Original-To-New Color-Wheel-Location Transform 704 may calculate the rotation to a new point on the color wheel may be mathematically calculated (or may even be transformed by way of a simple look-up table wherein the mathematical transformations of one point to another point through a given angle of rotation are previously stored). A Color-Wheel-Location-to-RGB transformation 706 from the new point on the color wheel to an RGB representation may also be performed mathematically or via table look-up. Thus, given an original color scheme with a plurality of colors, the transformations shown in FIG. 7 may implement the steps of FIG. 6 including the mapping 602, rotation 603, and determining corresponding new colors 604 steps without actually generating or displaying the actual color wheel of FIGS. 3, and 4A-4D.

FIG. 8 depicts an exemplary computing environment in which the invention may operate. In this environment, a process 802 executes code stored in memory 804. Memory 804 stores computer readable instructions including instructions implementing a graphical design application 810. The graphical design application 810 further includes instructions for implementing a graphical user interface 812 by which a graphical user interface is displayed on a display 808 such as a computer monitor, and by which the graphical design application receives user input via one or more user input devices 806 such as a mouse and keyboard. The graphical design application 810 further includes instructions for implementing a color scheme variation control 814 which generates color scheme variations, for example according to the method of FIG. 6. The processor 802 executes the instructions of the graphical design application 810, and its graphical user interface 812 and color scheme variation control 814. Operation of the graphical design application 810, graphical user interface 812, and color scheme variation control 814 may be as described previously with respect to FIGS. 1 through 7.

While exemplary embodiments of the invention have been discussed, the described embodiments are to be considered as illustrative rather than restrictive. The scope of the invention is as indicated in the following claims and all equivalent methods and systems.

What is claimed is:

1. A computer-implemented method for automatically generating a set of color scheme variations based on a current color scheme of an electronic document, the method comprising:
determining an original color scheme of an electronic design, the original color scheme comprising an original set of colors used to implement an electronic design;
mapping the colors in the original set of colors to respective points at respective locations on a color wheel;
rotating each of the points around the color wheel by a same rotation to respective new locations;
determining corresponding new colors associated with the rotated points at the respective new locations on the color wheel; and
presenting at least a subset of the new colors associated with the rotated points as a color scheme variation of the original color scheme.

2. The method of claim 1, further comprising rendering the electronic design using the color scheme variation.

3. The method of claim 1, further comprising repeating, at least once, the rotating step through the presenting step to present one or more additional color scheme variations of the original color scheme.

4. The method of claim 1, further comprising:
detecting user selection of one of the color scheme variations; and
rendering the electronic design using the selected color scheme variation.

5. The method of claim 1, wherein the mapping, rotating, and determining steps are performed using a mathematical transformation.

6. A computer-readable medium comprising program instructions which, when executed by a computer, implement a method for automatically generating a set of color scheme variations based on a current color scheme of an electronic document, the method comprising:
determining an original color scheme of an electronic design, the original color scheme comprising an original set of colors used to implement an electronic design;
mapping the colors in the original set of colors to respective points at respective locations on a color wheel;
rotating each of the points around the color wheel by a same rotation to respective new locations;
determining corresponding new colors associated with the rotated points at the respective new locations on the color wheel; and
presenting at least a subset of the new colors associated with the rotated points as a color scheme variation of the original color scheme.

7. The computer-readable medium of claim 6, further comprising rendering the electronic design using the color scheme variation.

8. The computer-readable medium of claim 6, further comprising repeating, at least once, the rotating step through the presenting step to present one or more additional color scheme variations of the original color scheme.

9. The computer-readable medium of claim 6, further comprising:
detecting user selection of one of the color scheme variations; and
rendering the electronic design using the selected color scheme variation.

10. The computer-readable medium of claim 6, wherein the mapping, rotating, and determining steps are performed using a mathematical transformation.

11. A system for automatically generating a set of color scheme variations based on a current color scheme of an electronic document, comprising:
a processor;
a display;
an input device which detects and receives user input;
a graphical design application executed by the processor which presents a graphical user interface on the display and receives user input from the input device to create a design in a work area of the graphical user interface; and
a color scheme variation control which determines an original color scheme of an electronic design, the original color scheme comprising an original set of colors used to implement an electronic design, maps the colors in the original set of colors to respective points at respective locations on a color wheel, rotates each of the points around the color wheel by a same rotation to respective new locations, determines corresponding new colors associated with the rotated points at the respective new locations on the color wheel, and presents at least a subset of the new colors associated with the rotated points as a color scheme variation of the original color scheme.

12. The system of claim 11, the graphical user interface of the graphical design application detecting user selection of one of the presented color scheme variations and rendering the design in the work area of the graphical user interface using the selected color scheme variation.

13. The system of claim 11, the color scheme variation control presenting a plurality of different color scheme variations based on the original color scheme.

14. The system of claim 11, wherein the color scheme variation control comprises:
a color representation transform which transforms a color value into a location of the corresponding color value on a color wheel;
a color wheel rotation transform which transforms an input coordinate on a color wheel to a new coordinate on the color wheel, the new coordinate comprising the input coordinate rotated on the color wheel by a predetermined rotation; and
a color wheel coordinate transform which transforms a color wheel coordinate to a corresponding color value.
